(19) United States
(12) Patent Application Publication
(10) Pub. No.: US 2013/0080584 A1
(43) Pub. Date: Mar. 28, 2013

(54) PREDICTIVE FIELD LINKING FOR DATA INTEGRATION PIPELINES

(71) Applicant: SnapLogic, Inc, San Mateo, CA (US)

(72) Inventor: Gregory D. BENSON, San Francisco, CA (US)

(73) Assignee: SNAPLOGIC, INC, San Mateo, CA (US)

(21) Appl. No.: 13/624,721

(22) Filed: Sep. 21, 2012

Related U.S. Application Data
(60) Provisional application No. 61/538,710, filed on Sep. 23, 2011.

(51) Int. Cl. G06F 15/16

(52) U.S. Cl. 709/217

(57) ABSTRACT

One embodiment of the present invention sets forth a mechanism for linking data fields across different components in a data pipeline. For a particular output data field in an upstream data component, a corresponding input data field in the downstream data component is identified based on an analysis of data types, string matching and previously created links.

### CROSS-REFERENCE TO RELATED APPLICATIONS

This application claims priority to U.S. Provisional Patent Application Ser. No. 61/538,710, filed Sep. 23, 2011, entitled “Predictive Field Linking for Data Integration Pipelines,” which is hereby incorporated herein by reference.

### BACKGROUND OF THE INVENTION

1. Field of the Invention

The present invention relates to the field of computer science and, more particularly to, predictive field linking for data integration pipelines.

2. Description of the Related Art

As known, a data pipeline orchestrates a flow of data from a source endpoint to a destination endpoint. A data pipeline typically includes data integration components that enable the transmission and/or transformation of data within the data pipeline. Each data integration component includes an input view and an output view, where each view is defined by a schema having a pre-identified set of field name and field type pairs

A problem that exists when assembling a data pipeline is that the different data integration components need to be connected to one another using field linking. For two data integration components serially connected to one another, linking involves matching the output schema of one data integration component with the input schema of the other data integration component. Conventionally, to match two different schemas, manual field-by-field linking is required. Such an approach is tedious, time-consuming and prone to error.

As the foregoing illustrates, what is needed in the art is a mechanism to link fields across two different components of a data pipeline in an efficient manner.

### SUMMARY OF THE INVENTION

One embodiment of the present invention sets forth a computer-implemented method for linking fields in an upstream component included in a data pipeline with an adjacent downstream component included in the data pipeline. The method includes the steps of identifying a first field in the upstream component and a set of candidate fields in the downstream component, and for each candidate field included in the set of candidate fields, computing a field linking score that indicates the likelihood of the candidate field corresponding to the first field. The method also includes the steps of selecting a first candidate field from the set of candidate fields that corresponds to the first field, creating a link between the first field and the first candidate field and executing the data pipeline such that data stored in the first field is transmitted to the first candidate field during execution.

One advantage of the disclosed technique is that the field linking engine automatically identifies corresponding fields across two connected components in a data pipeline. An end-user is therefore not required to manually link hundreds of output fields in a source component with input fields in a destination component. Consequently, assembling a data pipeline is a more efficient process for the end-user.

### BRIEF DESCRIPTION OF THE DRAWINGS

So that the manner in which the above recited features of the invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a conceptual diagram of a system configured to implement one or more aspects of the invention.

FIG. 2 is a conceptual diagram of a data pipeline generated within system of FIG. 1, according to one embodiment of the present invention.

FIG. 3A illustrates a more detailed view of read component included in data pipeline of FIG. 2, according to one embodiment of the present invention.

FIG. 3B illustrates a more detailed view of sort operations component included in data pipeline of FIG. 2, according to one embodiment of the present invention.

FIG. 3C illustrates a field linking between the two components of FIGS. 3A and 3B, according to one embodiment of the present invention.

FIGS. 4A and 4B set forth a flow diagram of method steps for linking an output field of an upstream component of a data pipeline with an input field of a downstream component of the data pipeline, according to one embodiment of the present invention.

FIG. 5 illustrates a conceptual block diagram of a general purpose computer configured to implement one or more aspects of the invention.

### DETAILED DESCRIPTION

In the following description, numerous specific details are set forth to provide a more thorough understanding of the invention. However, it will be apparent to one of skill in the art that the invention may be practiced without one or more of these specific details. In other instances, well-known features have not been described in order to avoid obscuring the invention.

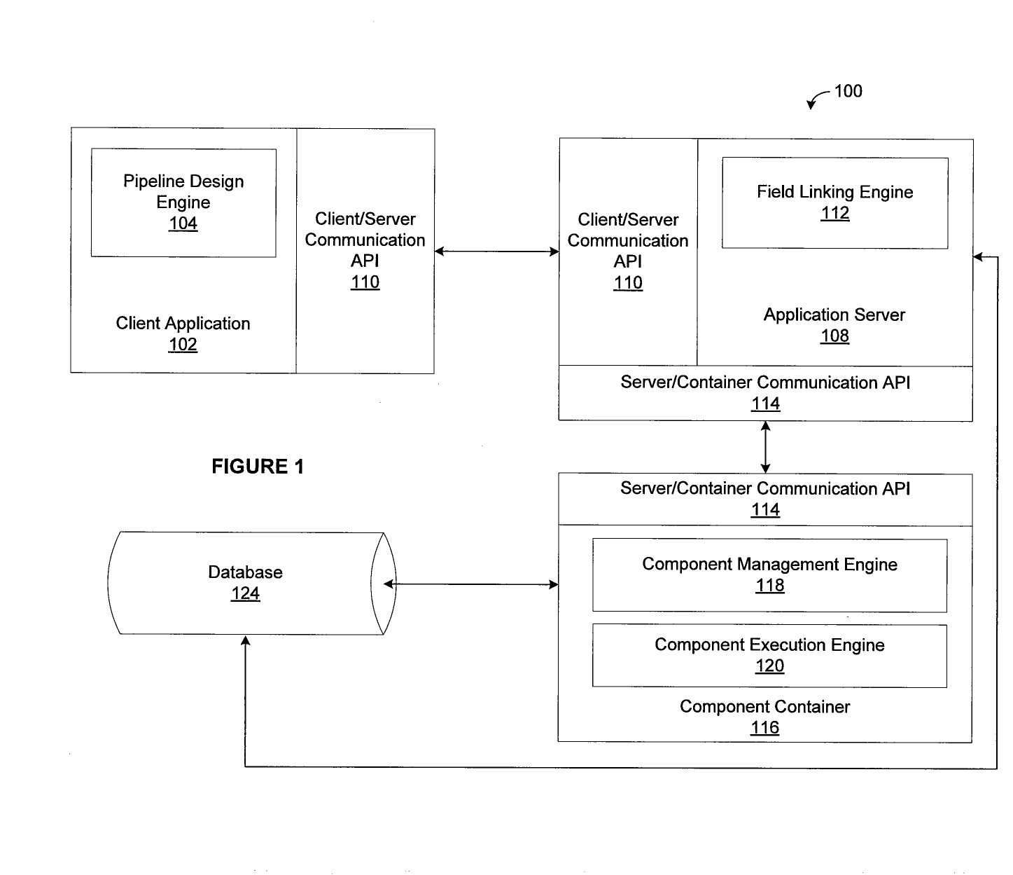

FIG. 1 illustrates a system 100 configured to implement one or more aspects of the invention. Note that the architecture depicted in FIG. 1 is one exemplary implementation and is not intended to limit the scope of the present invention in any way. As shown, system 100 includes, a client application 102, an application server 108 and a client/server communication application programming interface (API) 110. System 100 also includes a component container 115, a server/container communication API 114 and a database 124.

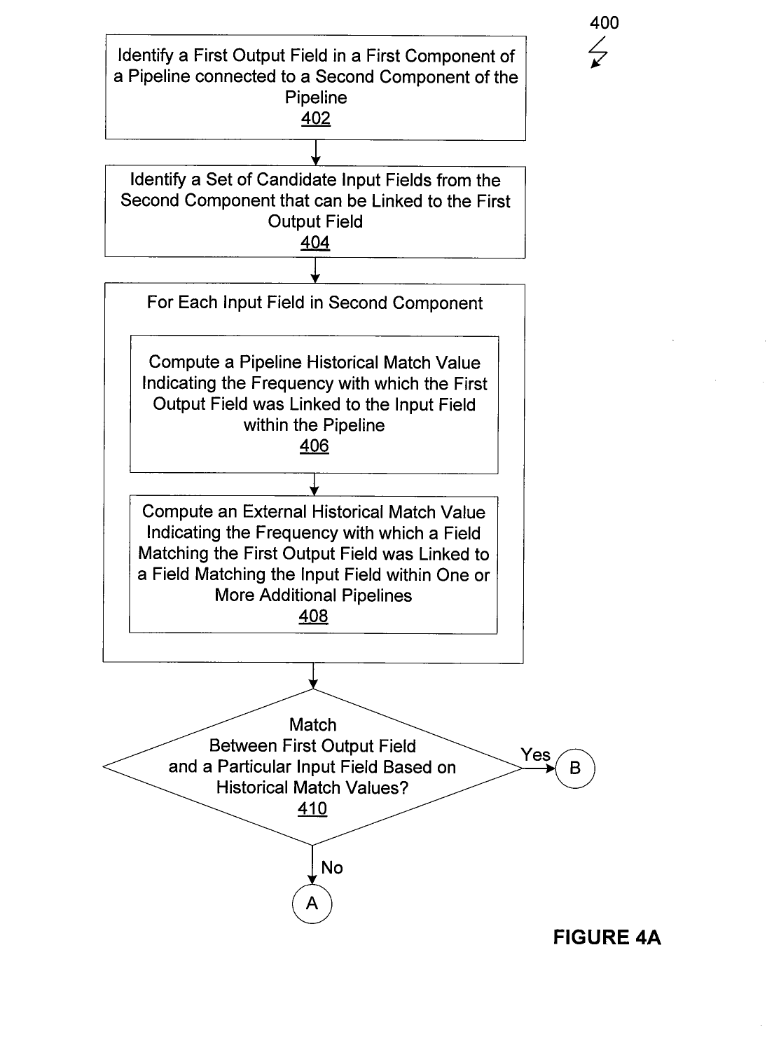

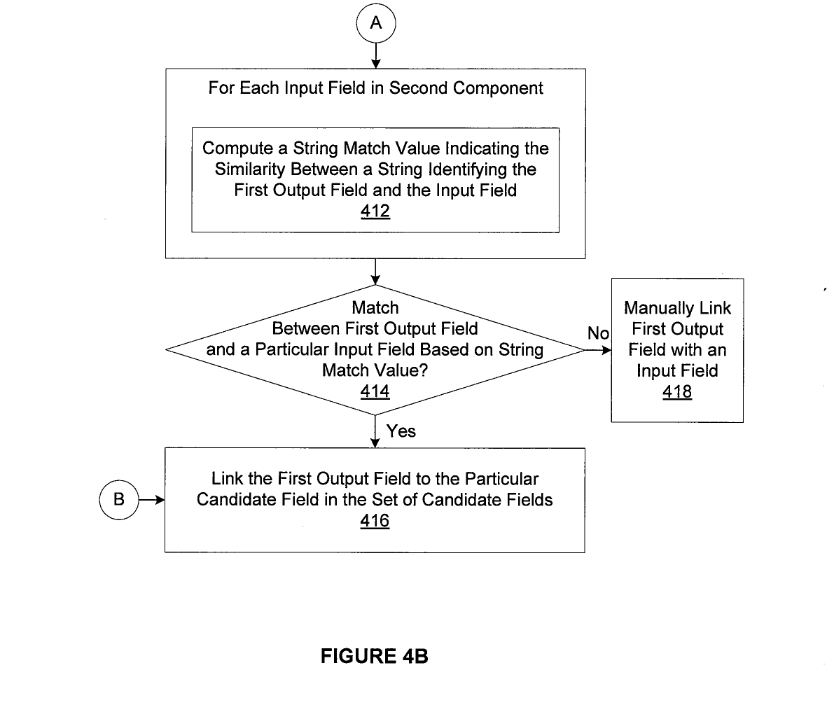

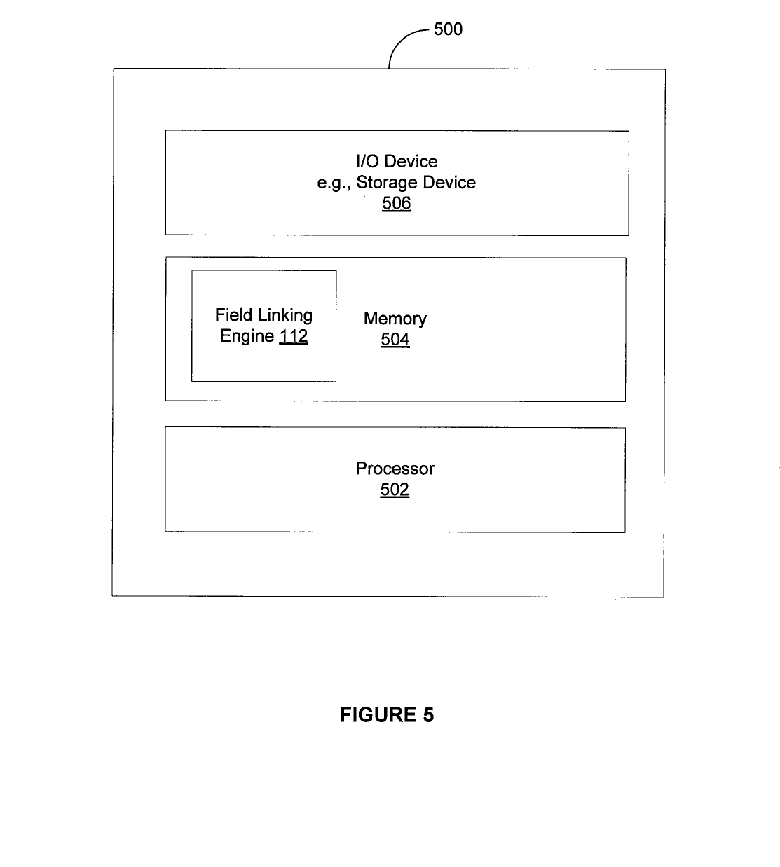

Client application 102 may execute on a personal computer, game console, personal digital assistant, mobile or computing tablet, or any other device suitable for practicing one or more embodiments of the present invention. FIG. 4 shows an example device on which client application 102 executes.

Client application 102 operates in conjunction with application server 108 and component container 116 to enable a user to construct and execute data pipelines. A data pipeline includes a collection of components and/or nested data pipelines linked together to orchestrate a flow of data between endpoints coupled to the data pipeline. For example, a simple data pipeline may read data from a rich site summary (RSS) feed, reformat the data, and write the reformatted data to a database. In such an example, the RSS feed and the database are the endpoints coupled to the pipeline. A component within a data pipeline is a software module that performs a subtask. Components are classified as connector components that read/write data or operator components that perform an action on data, such as a join operation or a filter operation.

At a high-level, client application 102 enables a user to create and persist new components, assemble new data pipelines, and execute data pipelines that have previously been assembled. To perform these operations, client application 102 communicates with application server 108 and component container 116. Application server 108 is a software-based server that communicates with client application 102 via client/server communication API 110 and performs support operations associated with pipeline assembly. Such support operations include data retrieval from database 124 and communicating with component container 116 via server/container communication API 114 to orchestrate component registration and execution operations. Finally, component container 116 is a software module that registers new components with the component repository and instantiates and executes components included in an assembled data pipeline. The operation of each of client application 102, application server 108 and component container 116 is described in greater detail below.

As shown, client application 102 includes a pipeline design engine 104. Pipeline design engine 104 is a configuration tool that allows a user to create new components, assemble new data pipelines and execute data pipelines that have previously been assembled. To perform these operations, pipeline design engine 104 communicates with application server 108 and component container 116, as described in greater detail below. In one embodiment, pipeline design engine 104 provides a drag-and-drop interface for creating components or combining pre-defined components and/or pipelines to create new data pipelines.

To assemble a particular data pipeline, pipeline design engine 104 also allows the user to create new components. If the user creates a new component, i.e., a new software module that performs a particular task, the pipeline design engine 104 allows the end-user to store the component in a component repository for future use. In one embodiment, components created by one end-user may be shared with one or more other end-users.

In one embodiment, the pipeline design engine 104 transmits a component registration request to application server 108 via client/server communication API 110 when the user requests to store a newly-created component in the component repository. The component registration request may include a component descriptor that specifies the name of the component, function of the component and other information related to the component. The component registration request may also include component logic written or configured by the end-user such that the component performs a specific function when executed.

Application server 108 forwards the component registration request to component container 116 via server/container communication API 114. Component management engine 118 within component container 116 processes the component registration request to parse out the component descriptor as well as the component logic from the component registration request. Component management engine 118 then stores the component descriptor and the component logic in a component repository within database 124.

In addition to creating new components, pipeline design engine 104 also allows users to view and select previously-defined components and/or previously-assembled pipelines which may be included in a data pipeline being assembled. In operation, to retrieve components and/or pipelines stored in the component repository, pipeline design engine 104 transmits a request to application server 108 via client/server communication API 110 specifying the components and/or pipelines that need to be retrieved. Application server 108 forwards the request to component management engine 118 via server/container communication API 114. In response to the request, component management engine 118 retrieves the component descriptors associated with the components specified by the request and transmits the descriptors to the pipeline design engine 104 via application server 108. The user is then able to view and select one or more of the retrieved components for inclusion in the data pipeline being assembled.

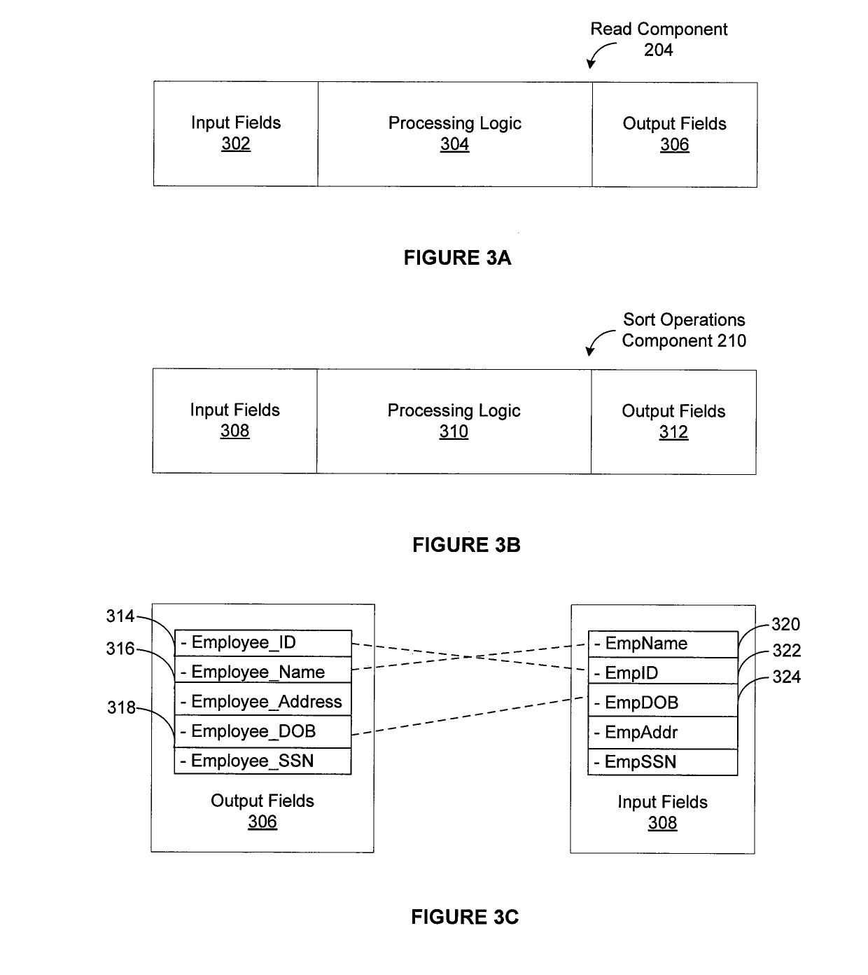

When a user assembles a pipeline having an upstream component coupled to a directly downstream component, output data fields in the upstream component need to be linked to input data fields in the downstream component. Field linking engine 112 in application server 108 enables automatic linking between output fields in the upstream component with input fields in the downstream component. The techniques implemented by field linking engine 112 are described in greater detail below in conjunction with FIG. 3C and FIGS. 4A and 4B.

Once the user assembles a data pipeline, pipeline design engine 104 may store the assembled data pipeline in the component repository and/or execute the data pipeline. Component execution engine 120 included in component container 116 processes requests received via application server 108 from pipeline design engine 104 for executing a particular data pipeline. For a particular data pipeline, component execution engine 120 identifies the various components included in the data pipeline and within nested pipelines included in the pipeline. Component execution engine 120 then executes each component in the order which the components are arranged within the data pipeline. In one embodiment, based on the type of data pipeline, component execution engine 120 causes the output generated by the execution of the data pipeline to be visually displayed to the user and/or stored in the manner specified by the data pipeline.

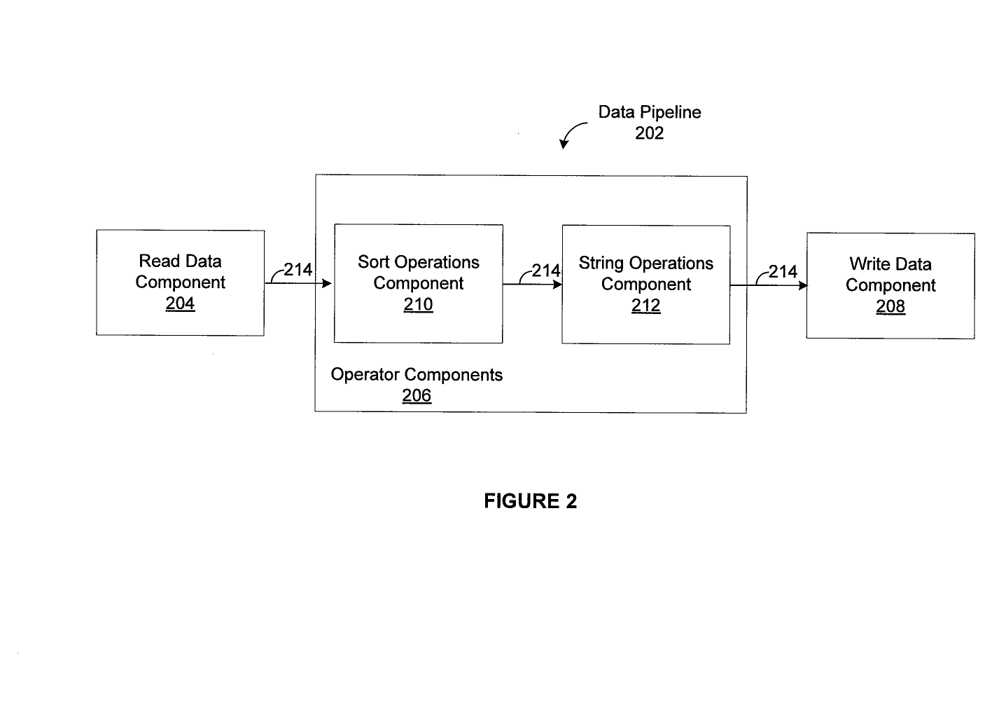

FIG. 2 is a conceptual diagram of a data pipeline 202 generated within system 100 of FIG. 1, according to one embodiment of the invention. Generally, data pipeline 202 includes multiple components coupled to one another via different data links. As shown, data pipeline 202 includes a read component 204, one or more operator components 206 and a write component 208.

Read component 204 is responsible for reading different types of data obtained from the various data source endpoints coupled to data pipeline 202. Data transformation components 206 are responsible for organizing and manipulating the data provided by read component 204 such that the data is transformed to generate output data. Write component 208 is responsible for writing the “final” data to client application 102 to database 124 (or elsewhere). By way of example, two data transformation components are shown, a sort operations component 210 and a string operations component 212. Sort operations component 210 may be configured to perform various sorting operations on the different types of data to reorganize those data, and string operations component 212 may be configured to run various operations on string data to manipulate that data.

As also shown, each component in FIG. 2 is coupled to data integration components via a data link 214. As persons skilled in the art will readily appreciate, data pipeline 202 may be configured in any technically feasible manner and may include any number of and any combination of data integration components. Thus, the architecture set forth in FIG. 2 is exemplary only and does not and is not intended to limit the scope of the present invention in any way.

FIG. 3A illustrates a more detailed view of read component 204 included in data pipeline 202 of FIG. 2, according to one embodiment of the present invention. As shown, read component 204 includes input fields 302, processing logic 304 and output fields 306. In operation, data being input into read component 204 is passed as input fields 302, where each input field 302 is associated with a field identifier, a data type and a corresponding value. Processing logic 304 operates on the input fields 302 to generate output data. The output data is stored in output fields 306, where each output field is associated with a field identifier, a data type and a corresponding value.

FIG. 3B illustrates a more detailed view of sort operations component 210 included in data pipeline 202 of FIG. 2, according to one embodiment of the present invention. As shown, sort operations component 210 includes input fields 308, processing logic 310 and output fields 312. In operation, data being input into sort operations component 210 is passed as input fields 308, where each input field 308 is associated with a field identifier, a data type and a corresponding value. Processing logic 304 performs a sort operation on one or more input fields 308 to generate output data. The output data is stored in output fields 312, where each output field is associated with a field identifier, a data type and a corresponding value.

FIG. 3C illustrates a field linking between the two components of FIGS. 3A and 3B, according to one embodiment of the invention. As shown, output fields 306 include an as Employee_ID field 314, Employee_Name field 316 and field Employee_DOB 318. Similarly, input fields 308 include several fields, such as EmpName 320 field, EmpID 322 field, and EmpDOB 324 field.

As discussed above, field linking engine 112 included in application server 108 creates links between output fields in an upstream component of a data pipeline with input fields of a downstream component of the data pipeline. In data pipeline 202, read component 204 is the upstream component and sort operations component 210 is directly downstream from read component 204. Thus, output fields 306 included in read component 204 need to be linked to corresponding input fields 308 included in sort operations component 210. The following discussion describes the linking techniques implemented by field linking engine 112 to link the output field 306, Employee_ID 314, with a corresponding input field 308. Persons skilled in the art would readily recognize that the techniques described may be applied to any other field in output fields 306.

In one embodiment, field linking engine 112 identifies the particular input field 308 corresponding to output field Employee_ID 314 based on data type matching and either linking history or field identifier similarity. In operation, field linking engine 112 first analyzes each input field 308 to determine whether the data type associated with the input field matches the data type associated with Employee_ID 314. If the data type does not match, then the particular input field 308 cannot be linked to Employee_ID 314. Once each input field 308 is analyzed for data type matching, the input fields 308 that cannot be linked are discarded from consideration and the remaining input fields 308 (“the candidate input fields 308”) are further analyzed.

For each candidate input field 308, field linking engine 112 computes a field linking score that indicates the likelihood of the input field 308 corresponding to Employee_ID 314. To compute the field linking score, field linking engine 112 first determines whether an input field 308 corresponding to Employee_ID 314 can be identified based on a historical analysis. In practice, field linking engine 112 determines the frequency with which Employee_ID 314 was previously linked to the particular candidate input field 308. More specifically, field linking engine 112 analyzes data pipeline 202 to determine whether Employee_ID 314 in a different instance of read component 204 was linked to the candidate input field. Field linking engine 112 records the number of links within the data pipeline 202 between Employee_ID 314 and the candidate input field 308 as the pipeline historical match value. Further, field linking engine 112 analyzes the component repository within database 124 to determine whether, across different data pipelines, whether Employee_ID 314 was linked to the candidate input field. Field linking engine 112 records the number of links identified in the component repository between Employee_ID 314 and the candidate input field 308 as the external historical match value.

In one embodiment, field linking engine 112 pre-processes the current pipeline and each of the existing pipelines to create a historical statistics table at the time application server 108 is initialized for efficiency purposes. Consequently, field linking engine 112 updates the historical statistics table as changes/additions are made to the pipelines.

Field linking engine 112 computes a pipeline historical match value and an external historical match value for each candidate input field 308 in the manner discussed above. Field linking engine 112 then ranks each of the candidate input fields 308 according to the historical match values to identify the particular input field 308 corresponding to Employee_ID 314. For example, historically “Employee_ID” may be linked to “emp” twenty times but “Employee_ID” may also be linked to “employeelD” thirty times. Field linking engine 112 uses these historical statistics to give a higher preference to linking “Employee_ID” to “employeelD” over “emp,” assuming both “employeelD” and “emp” are in the candidate input fields 308. Field linking engine 112 then creates a link between the identified candidate input field 308 and Employee_ID 314.

If the historical analysis performed by field linking engine 112 does not yield a match between Employee_ID 314 and a candidate input field 308, then field linking engine performs a string similarity analysis to identify the match. In practice, for each candidate input field 308, field linking engine 112 computes a field linking score based on a string match value that indicates the similarity between the string representation of the field identifier associated with Employee_ID 314, i.e., “Employee_ID,” and the string representation of the field identifier associated with the candidate input field 308. For example, for the candidate input field 308 EmpID 322, the string representation of EmpID 222, i.e., “EmpID” is compared with “Employee_ID” to determine the string match value. In one embodiment, the string match value is computed using a Levenshtein distance algorithm. Persons skilled in the art would readily recognize that any technique for determining the similarity between two strings is within the scope of present invention.

Field linking engine 112 computes a field linking score based on a string match value in the manner described above for each candidate input field 308 in the. As described above, the field linking score for each candidate input field 308 indicates the likelihood of the input field 308 corresponding to Employee_ID 314. Field linking engine 112 selects the candidate input field 308 that has the field linking score indicating the highest likelihood of corresponding to Employee_ID 314. In one embodiment, the candidate input field 308 having the highest field linking score is selected. Field linking engine 112 then creates a link between the selected candidate input field 308 and Employee_ID 314.

In one embodiment, once field linking engine 112 selects a particular candidate input field as corresponding to a particular output field, the user is notified of the selection via pipeline design engine 104. Pipeline design engine 104 provides the user with the opportunity to accept, reject or modify the identified linking.

As discussed above, field linking engine 112 implements the above techniques to identify an input field 308 corresponding to each output field 306. In one embodiment, as field linking engine 112 identifies an input field 308 as corresponding to a particular output field 306, the input field 308 is removed from the list of possible input fields 308 that may be matched to other output fields 306. Consequently, each time field linking engine 112 identifies a match between an input field 308 and an output field 306, the number of candidate input fields 308 that need to be evaluated for subsequent matches is reduced. Thus, by removing candidate input fields, field linking engine 112 is able to more accurately identify corresponding input fields 308 to the remaining output fields 306. Further, the iterative nature of the technique implemented by field linking engine 112 also increases the likelihood of identifying a corresponding input field 308 for each output field 306. Thus, the end-user benefits tremendously from not having to manually link fields across different components of the pipeline.

FIGS. 4A and 4B illustrate a method for linking an output field of an upstream component of a data pipeline with an input field of a downstream component of the data pipeline, according to one embodiment of the present invention.

Method 400 begins at step 402, where field linking engine 112 identifies a first output field in the upstream component, i.e., the first component, connected to the downstream component, i.e., the second component, in the data pipeline. At step 404, field linking engine 112 identifies a set of candidate input fields in the second component that may be linked to the first output field. In one embodiment, the set of candidate input fields includes only those input fields in the second component that have a data type matching the data type of the first output field in the first component.

At step 406, field linking engine 112 computes a pipeline historical match value that indicates the frequency with which the first output field has been linked to the candidate input field within the data pipeline. At step 408, field linking engine 112 analyzes the component repository within database 124 to compute an external historical match value that indicates the frequency with which the first output field has previously been linked to the candidate input field across different data pipelines.

Field linking engine 112 performs steps 404-408 described above for each candidate input field. At step 410, field linking engine 112 determines whether a corresponding input field matching the output field can be identified based on the historical match values computed for each candidate input field. In practice, field linking engine 112 ranks each of the candidate input fields according to the historical match values to identify the particular input field corresponding to the output field.

If, at step 410, a match based on historical match values is not found, then method 400 proceeds to step 412. At step 412, field linking engine 112, for each candidate input field, computes a string match value indicating a measure of similarity between the string representation of the field identifier associated with the first output field and the string representation of the field identifier associated with the candidate input field. At step 414, field linking engine 112 determines whether a corresponding input field matching the output field can be identified based on the string match values computed for each candidate input field.

If, at step 414, a match based on string match values is found, then method 400 proceeds to step 416. At step 416, creates a link between the matching candidate input field and the first output field. If, however, at step 414 a match based on string match values is not found, method 400 proceeds to step 418. At step 418, the end-user may manually link the first output field with any unlinked candidate input fields.

FIG. 5 illustrates a conceptual block diagram of a general purpose computer configured to implement one or more aspects of the invention. As shown, system 500 includes processor element 502 (e.g., a CPU), memory 504, e.g., random access memory (RAM) and/or read only memory (ROM), and various input/output devices 506, which may include storage devices, including but not limited to, a tape drive, a floppy drive, a hard disk drive or a compact disk drive, a receiver, a transmitter, a speaker, a display, a speech synthesizer, an output port, and a user input device such as a keyboard, a keypad, a mouse, and the like. Field linking engine 112 resides within memory 504 and executes on processor 502.

One advantage of the disclosed technique is that the field linking engine automatically identifies corresponding fields across two connected components in a data pipeline. An end-user is therefore not required to manually link hundreds of output fields in a source component with input fields in a destination component. Consequently, assembling a data pipeline is a more efficient process for the end-user.

The invention has been described above with reference to specific embodiments and numerous specific details are set forth to provide a more thorough understanding of the invention. Persons skilled in the art, however, will understand that various modifications and changes may be made thereto without departing from the broader spirit and scope of the invention. The foregoing description and drawings are, accordingly, to be regarded in an illustrative rather than a restrictive sense.

One embodiment of the invention may be implemented as a program product for use with a computer system. The program(s) of the program product define functions of the embodiments (including the methods described herein) and can be contained on a variety of computer-readable storage media. Illustrative computer-readable storage media include, but are not limited to: (i) non-writable storage media (e.g., read-only memory devices within a computer such as compact disc read only memory (CD-ROM) disks readable by a CD-ROM drive, flash memory, read only memory (ROM) chips or any type of solid-state non-volatile semiconductor memory) on which information is permanently stored; and (ii) writable storage media (e.g., floppy disks within a diskette drive or hard-disk drive or any type of solid-state random-access semiconductor memory) on which alterable information is stored.

The invention has been described above with reference to specific embodiments. Persons of ordinary skill in the art, however, will understand that various modifications and changes may be made thereto without departing from the broader spirit and scope of the invention as set forth in the appended claims. The foregoing description and drawings are, accordingly, to be regarded in an illustrative rather than a restrictive sense.

Therefore, the scope of embodiments of the present invention is set forth in the claims that follow.

What is claimed is:

1. A computer-implemented method for automatically configuring a data pipeline, the method comprising:
identifying a first field in an upstream component of the data pipeline and a set of candidate fields in a downstream component of the data pipeline;
for each candidate field included in the set of candidate fields, computing a field linking score that indicates the likelihood of the candidate field corresponding to the first field;
selecting a first candidate field from the set of candidate fields that corresponds to the first field;
creating a link between the first field and the first candidate field; and
executing the data pipeline such that data stored in the first field is transmitted to the first candidate field during execution.

2. The method of claim 1, wherein the first field is associated with a first data type, and identifying the set of candidate fields comprises identifying each field in the downstream component associated with the first data type.

3. The method of claim 1, wherein, for each candidate field, computing a field linking score comprises performing a string matching operation on a string identifier associated with the first field and a string identifier associated with the candidate field to determine the string similarity between the first field and the candidate field.

4. The method of claim 1, wherein, for each candidate field, computing a field linking score comprises determining a frequency of the first field being previously linked to the candidate field.

5. The method of claim 4, wherein determining the frequency comprises analyzing the data pipeline to identify one or more links between the first field and the candidate field.

6. The method of claim 4, wherein determining the frequency comprises analyzing one or more additional data pipeline to identify one or more links between the first field and the candidate field.

7. The method of claim 1, further comprising, providing the link between the first field and the first candidate field to a user for evaluation.

8. The method of claim 1, further comprising, executing the data pipeline, wherein, during execution, a set of input data is processed by the upstream component to generate output data, wherein a portion of the output data is stored in the first field, and wherein the portion of the output data is transmitted to the first candidate field via the link.

9. A computer readable storage medium for storing instructions that, when executed by a processor, cause the processor to automatically configure a data pipeline, by performing the steps of:
identifying a first field in an upstream component of the data pipeline and a set of candidate fields in a downstream component of the data pipeline;
for each candidate field included in the set of candidate fields, computing a field linking score that indicates the likelihood of the candidate field corresponding to the first field;
selecting a first candidate field from the set of candidate fields that corresponds to the first field;
creating a link between the first field and the first candidate field; and
executing the data pipeline such that data stored in the first field is transmitted to the first candidate field during execution.

10. The computer readable storage medium of claim 9, wherein the first field is associated with a first data type, and identifying the set of candidate fields comprises identifying each field in the downstream component associated with the first data type.

11. The computer readable storage medium of claim 9, wherein, for each candidate field, computing a field linking score comprises performing a string matching operation on a string identifier associated with the first field and a string identifier associated with the candidate field to determine the string similarity between the first field and the candidate field.

12. The computer readable storage medium of claim 9, wherein, for each candidate field, computing a field linking score comprises determining a frequency of the first field being previously linked to the candidate field.

13. The computer readable storage medium of claim 12, wherein determining the frequency comprises analyzing the data pipeline to identify one or more links between the first field and the candidate field.

14. The computer readable storage medium of claim 12, wherein determining the frequency comprises analyzing one or more additional data pipeline to identify one or more links between the first field and the candidate field.

15. The computer readable storage medium of claim 9, further comprising, providing the link between the first field and the first candidate field to a user for evaluation.

16. The computer readable storage medium of claim 9, further comprising, executing the data pipeline, wherein, during execution, a set of input data is processed by the upstream component to generate output data, wherein a portion of the output data is stored in the first field, and wherein the portion of the output data is transmitted to the first candidate field via the link.

17. A computing device, comprising:
a memory; and
a processor configured to:
identify a first field in an upstream component included in a data pipeline and a set of candidate fields in a downstream component included in the data pipeline,
for each candidate field included in the set of candidate fields, compute a field linking score that indicates the likelihood of the candidate field corresponding to the first field,
select a first candidate field from the set of candidate fields that corresponds to the first field,
create a link between the first field and the first candidate field, and
execute the data pipeline such that data stored in the first field is transmitted to the first candidate field during execution.

18. The computing device of claim 17, wherein the first field is associated with a first data type, and the processor is configured to identify each field in the downstream component associated with the first data type.

19. The computing device of claim 17, wherein, for each candidate field, the processor is configured to compute a field linking score by performing a string matching operation on a string identifier associated with the first field and a string identifier associated with the candidate field to determine the string similarity between the first field and the candidate field.

20. The computing device of claim 17, wherein, for each candidate field, the processor is configured to compute a field linking score by determining a frequency of the first field being previously linked to the candidate field
